(19) United States
(12) Patent Application Publication
(10) Pub. No.: US 2017/0229210 A1
(43) Pub. Date: Aug. 10, 2017

(54) HARNESS FOR ELECTRICAL CONNECTION BETWEEN A PLURALITY OF DEVICES

(71) Applicant: SAFRAN ELECTRICAL & POWER, Blagnac Cedex (FR)

(72) Inventors: Flavien KOLIATENE, Cintegabelle (FR); Michel DUNAND, Balma (FR)

(21) Appl. No.: 15/120,159

(22) PCT Filed: Feb. 19, 2015
(86) PCT No.: PCT/FR2015/050401

§ 371 Date: Aug. 19, 2016

(30) Foreign Application Priority Data
Feb. 21, 2014 (FR) 1451402

(51) Int. Cl. H01B 7/00; H01B 11/14; H01B 9/02

(52) U.S. Cl. CPC H01B 7/0045; H01B 9/02; H01B 11/14

(57) ABSTRACT

A harness for electrical connection between a plurality of devices, the harness including a bundle formed by one or more electric cables surrounded by a protective sheath. The harness includes a plurality of electromagnetic attenuator rods or cords extending along the bundle inside the protective sheath, each electromagnetic attenuator rod or cord being made at least in part out of a magnetic material, the rods or cords separating the electric cables of the bundle or being interposed between the bundle and the protective sheath.

### BACKGROUND OF THE INVENTION

The present invention relates to electrical harnesses and to limiting the electromagnetic disturbances generated by such harnesses. The invention relates more particularly but not exclusively to limiting electromagnetic disturbances in the electrical harnesses used in aircraft.

Electromagnetic compatibility (EMC) is essential for proper operation of a system. In an assembly of the type comprising a converter, a cable, and a machine, the transmission of so-called “power” signals between electronic power devices (converter) and loads (machine/actuators) constitutes a source of numerous disturbances that are due in particular to the switching of the switches, these disturbances being transmitted by electrical conduction and radiation downstream and upstream relative to the converter. Specifically, the increase in the performance of assemblies of the converter-cable-machine type requires semiconductor components to be used that operate at ever higher frequencies with switching times that are very fast, thereby leading to an electromagnetic environment that is very constricting. In this kind of system, the disturbances occur either in common mode, or in differential mode. In an aircraft, these disturbances not only degrade the bearings of the motor, but they also propagate towards the power supply. This propagation leads to radiated disturbances that can lead to malfunctions in nearby equipment, in particular low power electronic systems. These disturbances represent a significant portion of the electromagnetic compatibility problems that need to be solved, in particular in the field of aviation, which is going towards generations of airplanes that are ever “more electric”.

The function of transmitting electrical power is provided by harnesses. An electrical harness is a set of electric wires or cables of different gauges grouped together in a bundle and running together in order to reach connectors. A harness may include bulkhead connectors through partitions. A harness may be made up of a plurality of branches. A harness may optionally include a protective sheath, e.g. made using an insulating tape or a braid of textile or metal material. A harness is said to be “shielded” when the protective sheath is conductive, as applies for example with a metal braid.

In the context of programs for developing ever more electric airplanes, harnesses are becoming more and more numerous. The FAA and EASA regulation organizations now consider electric harnesses to be systems in their own right that need to satisfy electrical wiring interconnection system (EWIS) requirements.

The disturbances generated in harnesses by power converters and that constitute the source of electromagnetic radiation are of two types: common mode disturbances and differential mode disturbances. These electromagnetic disturbances propagate in cables that are capable of transmitting pulse width modulation (PWM) type signals or of transmitting high voltage direct current (HVDC) power supplies. The increasing length of cables does not facilitate reducing conducted or radiated disturbances, since both common mode and differential mode disturbances increase with increasing length of cable, where cable length may lie in the range one meter to several tens of meters.

Shielded harnesses are commonly used for addressing electromagnetic compatibility problems. The conductive protective sheath covers the entire harness all the way to its connectors and including its branches, if any. The purpose of a harness of this type is to act above a few hundreds of hertz (Hz) both to contain conducted and radiated emissions inside the shielding sheath and also to exclude conducted and radiated emissions from sources lying outside the harness so as to avoid electromagnetic disturbances. The shielding is generally considered as a topological barrier characterized by its transfer impedance.

Nevertheless, that type of shielding serves essentially to attenuate the signals conducted or radiated in common mode as generated by the converter, without handling the disturbances generated in differential mode even though they are, a priori, more troublesome since they are transmitted in parallel to differential loads and are therefore superposed directly on useful signals. In addition, disturbances in common mode are very easily transformed into disturbances in differential mode whenever an impedance unbalance appears in devices connected to the ends of the harness, with such unbalance sometimes coming from the harness itself, in particular as a result of the presence of branches and connectors.

The use of filters at electronic power level can also constitute a solution, but it presents the drawback of increasing the weight of the system very significantly.

Consequently, there exists a need to have a harness that serves to minimize disturbances, both in differential mode and in common mode.

### OBJECT AND SUMMARY OF THE INVENTION

To this end, the present invention provides a harness for electrical connection between a plurality of devices, said harness comprising a bundle made up of one or more electric cables surrounded by a protective sheath, the harness being characterized in that it includes at least one or more electromagnetic attenuator rods or cords extending along the bundle inside the protective sheath, each electromagnetic attenuator rod or cord being made at least in part out of a magnetic material, and in that the rods or cords separate the electric cables of the bundle or are interposed between the bundle and the protective sheath.

Thus, the harness of the invention presents mutual induction that is much greater than that of prior art harnesses, thereby enabling disturbances to be limited in differential mode and in common mode, and improving the ability of the harness to perform filtering. Specifically, a current always generates a magnetic field, and vice versa, so variations in the magnetic field induce electric currents in neighboring conductors. The presence of one or more electromagnetic attenuator rods or cords made at least in part out of a magnetic material and placed under the protective sheath makes it possible to provide self-induction in the harness that opposes current fluctuations.

When the electromagnetic attenuator rods or cords are interposed between the bundle and the protective sheath, they serve mainly to limit disturbances in common mode.

In a variant, when the electromagnetic attenuator rods or cords separate the electric cables of the bundle, they serve mainly to limit disturbances in differential mode.

When the electric cables of the bundle are twisted, the rods or cords are preferably twisted at a pitch similar to the twist pitch of the electric cables in order to provide overall mechanical stability.

In a particular aspect of the harness of the invention, each electromagnetic attenuator rod or cord is made out of a composite material comprising a matrix of flexible material filled with particles of at least one magnetic material. Thus, the electromagnetic attenuator cords or rods are suitable for performing their function of limiting electromagnetic disturbances without reducing the initial flexibility of the harness.

The invention also provides an aircraft including at least one harness of the invention for transferring power between a source of electricity and a load.

### BRIEF DESCRIPTION OF THE DRAWINGS

Other characteristics and advantages of the invention appear from the following description of particular embodiments of the invention given as non-limiting examples and with reference to the accompanying drawings, in which:

FIG. 1 is a perspective view of a harness in accordance with an embodiment of the invention;

FIG. 2A is a perspective view of a harness in accordance with another embodiment of the invention;

FIG. 2B is a perspective view showing the twisting between the cables of the bundle and the electromagnetic attenuator elements of the FIG. 2A harness;

FIG. 3 is a perspective view of a harness in accordance with another embodiment of the invention;

FIG. 4 is a perspective view of a harness in accordance with another embodiment of the invention;

FIG. 5 is a perspective view of a harness in accordance with another embodiment of the invention;

FIG. 6 is a perspective view of a harness in accordance with another embodiment of the invention; and

FIG. 7 is a perspective view showing the structure of the electromagnetic attenuator element of the FIG. 6 harness.

### DETAILED DESCRIPTION OF AN EMBODIMENT

The present invention proposes a harness suitable for use particularly, but not exclusively, for transmitting energy and/or information (measurement, control, etc. signals) between electrical or electronic devices on board aircraft. The harness of the invention is particularly suitable for transferring power between a source of electricity and a load (e.g. an actuator). As explained below in detail, the structure of the harness of the invention is remarkable in that it serves to increase the mutual induction of the bundle of the harness in common mode or in differential mode by the presence of one or more electromagnetic attenuator elements.

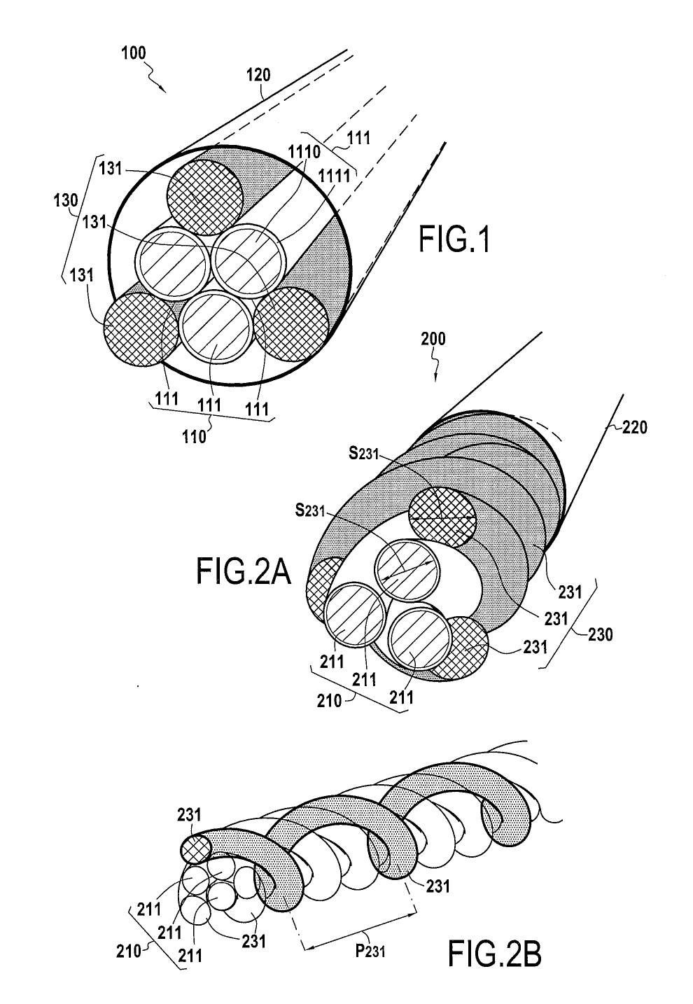

A harness 100 in compliance with an embodiment of the invention is shown in FIG. 1. The harness 100 comprises a central bundle 110 formed in this example by three electric cables 111, each made up of a conductor wire 1110 surrounded by an insulating sheath 1111, there being a protective sheath 120 surrounding the bundle 110. The protective sheath 120 may be made out of a flexible conductive material, such as for example a metal braid (shielded harness), or out of an electrically insulating material, the protective sheath surrounding the entire harness together with any branches all the way to its connectors (not shown in FIG. 1).

In accordance with the invention, the harness 100 also includes electromagnetic attenuator elements 130 that are constituted in this example by three rods or cords 131 made up at least in part out of a magnetic material and interposed between the central bundle 110 and the shielding sheath 120. When the electric cables of the bundle are not twisted, as in FIG. 1, the cords 131 extend axially along the harness, i.e. parallel to the cables 111 of the bundle 110. The cords 131 are distributed uniformly around the bundle 110.

FIG. 2A shows the situation in which the electric cables 211 of a bundle 210 are twisted inside the protective sheath 220 of a harness 200. Under such circumstances, the cords 231 constituting the electromagnetic attenuator elements 230 are likewise twisted at a pitch P₂₃₁ identical to the pitch at which the cables 211 are twisted (FIG. 2B). In addition, in order to ensure good mechanical stability for the cable-and-cord assembly, the cords 231 preferably present a section S₂₃₁ that corresponds to about 20% of the section S₂₁₁ of the cables 211 of the bundle.

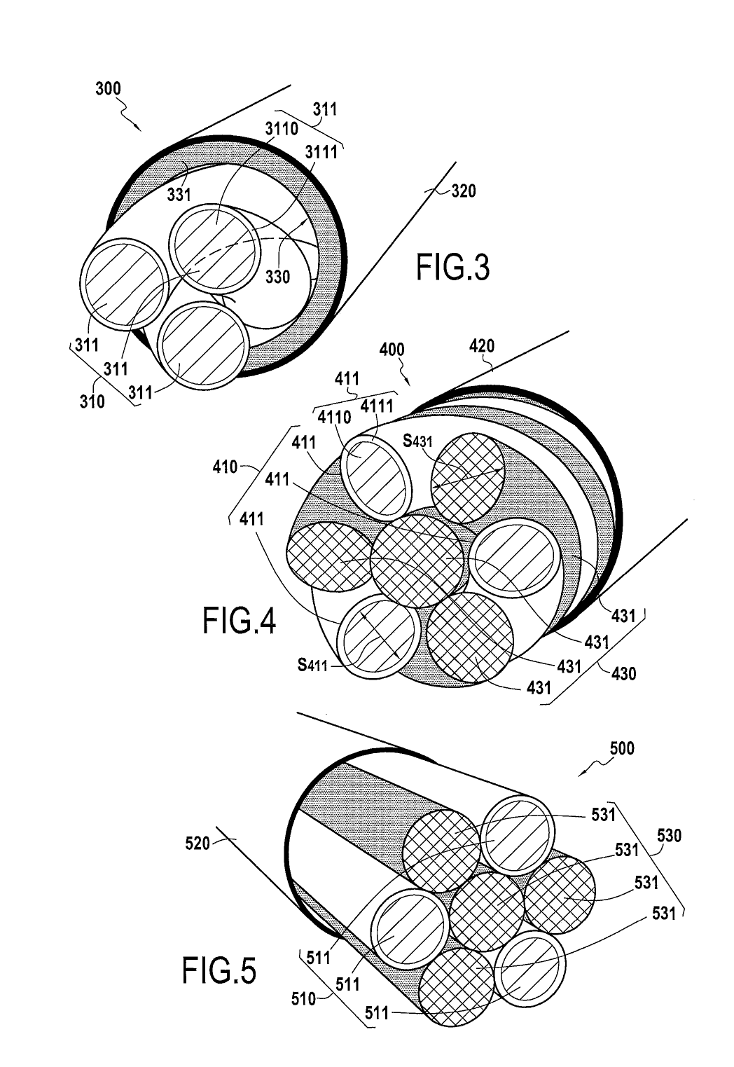

FIG. 3 shows a harness 300 comprising a bundle 310 formed in this example by three electric cables 311, each made up of a conductor wire 3110 surrounded by an insulating sheath 3111, there being a protective sheath 320 surrounding the bundle 310, the protective switch 320 possibly be constituted by a conductive material or by an electrically insulating material, the protective sheath surrounding the entire harness together with any branches all the way to its connectors (not shown in FIG. 3). The harness 300 differs from the harnesses 100 and 200 described above in that the cables 311 are surrounded by an electromagnetic attenuator element 330 constituted by a hollow tube 331 interposed between the bundle 310 and the shielding sheath 320. The hollow tube is made at least in part out of magnetic material.

In the harnesses 100, 200, and 300, the electromagnetic attenuator element(s) is/are arranged around the cables of the central bundle constituting the live wires and they serve mainly to limit common mode disturbances. Since the electromagnetic attenuator elements are made at least in part out of magnetic material, they are suitable for filtering all disturbances generated in common mode in the central bundle by increasing the mutual induction thereof. Nevertheless, when electromagnetic attenuator elements are used that are in the form of cords presenting a section that is significantly smaller than the sections of the electric cables of the bundle, then filtering takes place more probably on disturbances conducted in differential mode.

FIG. 4 shows a harness 400 in another embodiment of the invention. The harness 400 comprises a central bundle 410 constituted in this example by three electric cables 411, each made up of a conductor wire 4110 surrounded by an insulating sheath 4111, there being a protective sheath 420 surrounding the bundle 410, the protective sheath 420 possibly being constituted by a conductive material or by an electrically insulating material, the protective sheath covering the entire harness together with any branches all the way to its connectors (not shown in FIG. 1).

In this embodiment, the harness also has electromagnetic attenuator elements 430 constituted by four rods or cords 431 made at least in part out of a magnetic material and separating the electric cables 411 of the central bundle 410. When the electric cables of the bundle are twisted, as shown in FIG. 4, the cords 431 are likewise twisted at the same pitch as the cables 411. In addition, in order to provide good mechanical stability to the cable-and-cord assembly, the cords 431 preferably present a section S₄₃₁ that is identical to the section S₄₁₁ of the cables 411 of the bundle.

When the electric cables of the central bundle are not twisted, as shown in FIG. 5, the cords 531 constituting the electromagnetic attenuator elements 530 extend axially inside the protective sheath 520 of the harness 500, i.e. parallel to the cables 511 of the bundle 510.

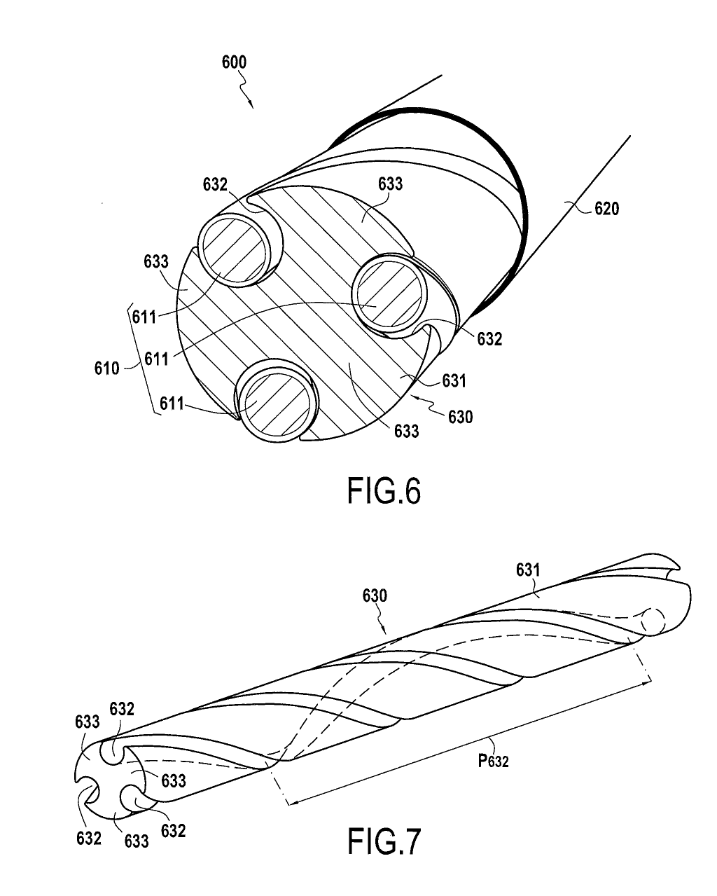

In a variant embodiment, the cables of the central bundle may also be separated with a one-piece core as shown in FIG. 6. In FIG. 6, a harness 600 comprises a bundle 610 formed in this example by three electric cables 611 and a protective sheath 620 surrounding the bundle 610 (which sheath may be conductive or insulating), and it also includes an electromagnetic attenuator element 630 constituted by a one-piece core 631. More precisely, the core 631 has housings 632 each serving to receive one of the cables 611 of the bundle 610. Once the cables 611 have been placed in the housing 632 they are separated from one another by walls 633 present between the housings 632. When the electric cables 611 are twisted, as shown, the housings 632 in the one-piece core 630 are helical in shape at a pitch P₆₃₂ corresponding to the pitch defined for twisting the cables, as shown in FIG. 7. When the electric cables of the central bundle are not twisted, then the housings in the one-piece core extend axially in the harness, i.e. parallel to the cables of the bundle and in the same separation position for the cables as shown in section for the harness in FIG. 6.

In harnesses 400, 500, and 600 the electromagnetic attenuator element(s) is/are arranged around the cables of the central bundle constituting the live wires and they serve mainly to limit disturbances in differential mode. Since the electromagnetic attenuator elements are made at least in part out of magnetic material, they are suitable for filtering all of the disturbances generated in differential mode in the central bundle by increasing its mutual induction.

In accordance with the invention, the above-described electromagnetic attenuator elements, i.e. the cords 131, 231, 431, and 531, the tube 331, and the one-piece core 631 are made from a material that is magnetic or partially magnetic. Among suitable magnetic materials, mention may be made in particular of iron, cobalt, nickel, manganese, and ferrites. Nevertheless, in order to conserve the initial flexibility of the harness, the electromagnetic attenuator elements are preferably made out of a composite material comprising a matrix made of flexible and/or pliable material filled with particles of one or more magnetic materials. By way of example, the above-described electromagnetic attenuator elements may be made using a polymer matrix of poly-tetrafluoroethylene (PTFE or Teflon™) type, of ethylene-tetrafluoroethylene (ETFE or Tefzel™) type, of perfluoroalkoxy (PFA or tetrafluoroethylene) type, or of fluorinated ethylene propylene copolymer (FEP or tetrafluoroethylene or perfluoropropylene) type filled with a powder of particles of one or more magnetic materials selected in particular from iron, cobalt, nickel, manganese, and ferrites. Such a composite material having 85% by weight of magnetic material filler makes it possible to reach performance of about 50% for the function of filtering disturbances in the harness. Such materials have been developed in particular by the supplier L.E.A.D. under the name “MUSORB”. Nevertheless, the proportion of magnetic filler in the composite material is defined as a function of the application and of the desired filtering performance. The composite material constituting the electromagnetic attenuator elements may also be made using a foam, such as a polyurethane or Styrofoam™ foam filled with particles of magnetic material(s). Various technologies can be used for shaping electromagnetic attenuator elements. When using cords or rods or tubes, it is possible for example to form these elements by die extrusion. The tubes may also be shaped by winding a tape of filled polymer or from a sheath. When a one-piece core is used, like the above-described core 430 it may be made by molding.

Any of the embodiments shown in FIGS. 1 to 3 may be combined with any of the embodiments shown in FIGS. 4 to 7 in order to form a harness suitable for limiting disturbances both in common mode and in differential mode, with this combining of filtering nevertheless having an impact on the flexibility and the total weight of the harness.

1. A harness for electrical connection between a plurality of devices, said harness comprising: a bundle made up of one or more electric cables surrounded by a protective sheath, and at least one or more electromagnetic attenuator rods or cords extending along the bundle inside the protective sheath, each electromagnetic attenuator rod or cord being made at least in part out of a magnetic material, wherein the rods or cords separate the electric cables of the bundle or are interposed between the bundle and the protective sheath.

2. A harness according to claim 1, wherein the bundle comprises twisted electric cables, and wherein the rods or cores are twisted at a pitch similar to a twist pitch of the electric cables.

3. A harness according to claim 1, wherein each electromagnetic attenuator rod or cord is made out of a composite material comprising a flexible matrix material filled with particles of at least one magnetic material.

4. An aircraft including at least one harness according to claims 1, said at least one harness being for transferring power between a source of electricity and a load.
